(19) United States
(12) Patent Application Publication
(10) Pub. No.: US 2024/0370346 A1
(43) Pub. Date: Nov. 7, 2024

(54) SYSTEMS AND METHODS FOR MANAGING BENCHMARK AND OBJECT DEPENDENCIES

(71) Applicant: JPMORGAN CHASE BANK, N.A., New York, NY (US)

(72) Inventor: Louis ZHUANG, New York, NY (US)

(21) Appl. No.: 18/313,201

(22) Filed: May 5, 2023

(51) Int. Cl. G06F 11/34; G06F 16/901

(52) U.S. Cl. CPC G06F 11/3428; G06F 16/9024

(57) ABSTRACT

In some aspects, the techniques described herein relate to a method including: determining a number of dependencies on corresponding calibrating objects for each of a plurality of benchmarks; generating a directed graph, wherein the directed graph is based on the plurality of benchmarks, the number of dependencies, and the corresponding calibrating objects; generating a directed acyclic graph from the directed graph, wherein groups of calibrating objects are nodes of the directed acyclic graph; assigning first-level groups of calibrating nodes to compute resources, wherein the first-level groups of calibrating objects have no outside dependencies; recalibrating, by the compute resources, the first-level groups of calibrating objects; assigning second-level groups of calibrating objects to the compute resources, wherein each of the second level groups of calibrating objects has an outside dependency on one of the calibrating objects in one of the first level groups.

### BACKGROUND

### 1. Field of The Invention

Aspects generally relate to systems and methods for managing benchmark and object dependencies.

### 2. Description of the Related Art

Benchmarks are routinely used by organizations for various comparisons. Some organizations may rely heavily on benchmarks that produce comparison values based on interrelated and/or hierarchical calibrating objects. When only a small number of hierarchical levels or interrelations exist, dependencies may be tracked and managed manually. However, when an organization provides and/or relies on hundreds of benchmark models that utilize possibly thousands of interrelated calibrating objects, managing dependencies among the benchmarks and calibrating objects is a much greater challenge.

### SUMMARY

In some aspects, the techniques described herein relate to a method including: determining a number of dependencies on corresponding calibrating objects for each of a plurality of benchmarks; generating a directed graph, wherein the directed graph is based on the plurality of benchmarks, the number of dependencies, and the corresponding calibrating objects; generating a directed acyclic graph from the directed graph, wherein groups of calibrating objects are nodes of the directed acyclic graph; assigning first-level groups of calibrating objects to compute resources, wherein the first-level groups of calibrating objects have no outside dependencies; recalibrating, by the compute resources, the first-level groups of calibrating objects; and assigning second-level groups of calibrating objects to the compute resources, wherein each of the second-level groups of calibrating objects has an outside dependency on a one of the calibrating objects in one of the first-level groups of calibrating objects.

In some aspects, the techniques described herein relate to a method, including: recalibrating, by the compute resources, the second-level groups of calibrating objects.

In some aspects, the techniques described herein relate to a method, wherein recalibrating the second-level groups of calibrating objects uses calibrating objects from the first-level groups of calibrating objects.

In some aspects, the techniques described herein relate to a method, wherein a first group in the first-level groups of calibrating objects is assigned to a first compute resource and a second group in the first-level groups of calibrating objects is assigned to a second compute resource.

In some aspects, the techniques described herein relate to a method, wherein the first compute resource and the second compute resource recalibrate the first group and the second group concurrently.

In some aspects, the techniques described herein relate to a method, wherein a benchmark is re-associated with a corresponding calibrating object in one of the first-level groups of calibrating objects.

In some aspects, the techniques described herein relate to a method, wherein the benchmark is recalibrated.

In some aspects, the techniques described herein relate to a system including at least one computer including a processor, wherein the at least one computer is configured to: determine a number of dependencies on corresponding calibrating objects for each of a plurality of benchmarks; generate a directed graph, wherein the directed graph is based on the plurality of benchmarks, the number of dependencies, and the corresponding calibrating objects; generate a directed acyclic graph from the directed graph, wherein groups of calibrating objects are nodes of the directed acyclic graph; assign first-level groups of calibrating objects to compute resources, wherein the first-level groups of calibrating objects have no outside dependencies; recalibrate, by the compute resources, the first-level groups of calibrating objects; and assign second-level groups of calibrating objects to the compute resources, wherein each of the second-level groups of calibrating objects has an outside dependency on a one of the calibrating objects in one of the first-level groups of calibrating objects.

In some aspects, the techniques described herein relate to a system, wherein the at least one computer is configured to: recalibrating, by the compute resources, the second-level groups of calibrating objects.

In some aspects, the techniques described herein relate to a system, wherein recalibrating the second-level groups of calibrating objects uses calibrating objects from the first-level groups of calibrating objects.

In some aspects, the techniques described herein relate to a system, wherein a first group in the first-level groups of calibrating objects is assigned to a first compute resource and a second group in the first-level groups of calibrating objects is assigned to a second compute resource.

In some aspects, the techniques described herein relate to a system, wherein the first compute resource and the second compute resource recalibrate the first group and the second group concurrently.

In some aspects, the techniques described herein relate to a system, wherein a benchmark is re-associated with a corresponding calibrating object in one of the first-level groups of calibrating objects.

In some aspects, the techniques described herein relate to a system, wherein the benchmark is recalibrated.

In some aspects, the techniques described herein relate to a non-transitory computer readable storage medium, including instructions stored thereon, which instructions, when read and executed by one or more computer processors, cause the one or more computer processors to perform steps including: determining a number of dependencies on corresponding calibrating objects for each of a plurality of benchmarks; generating a directed graph, wherein the directed graph is based on the plurality of benchmarks, the number of dependencies, and the corresponding calibrating objects; generating a directed acyclic graph from the directed graph, wherein groups of calibrating objects are nodes of the directed acyclic graph; assigning first-level groups of calibrating objects to compute resources, wherein the first-level groups of calibrating objects have no outside dependencies; recalibrating, by the compute resources, the first-level groups of calibrating objects; and assigning second-level groups of calibrating objects to the compute resources, wherein each of the second-level groups of calibrating objects has an outside dependency on a one of the calibrating objects in one of the first-level groups of calibrating objects.

In some aspects, the techniques described herein relate to a non-transitory computer readable storage medium, including: recalibrating, by the compute resources, the second-level groups of calibrating objects.

In some aspects, the techniques described herein relate to a non-transitory computer readable storage medium, wherein recalibrating the second-level groups of calibrating objects uses calibrating objects from the first-level groups of calibrating objects.

In some aspects, the techniques described herein relate to a non-transitory computer readable storage medium, wherein a first group in the first-level groups of calibrating objects is assigned to a first compute resource and a second group in the first-level groups of calibrating objects is assigned to a second compute resource.

In some aspects, the techniques described herein relate to a non-transitory computer readable storage medium, wherein the first compute resource and the second compute resource recalibrate the first group and the second group concurrently.

In some aspects, the techniques described herein relate to a non-transitory computer readable storage medium, wherein a benchmark is re-associated with a corresponding calibrating object in one of the first-level groups of calibrating objects.

### BRIEF DESCRIPTION OF THE DRAWINGS

FIG. 1a is a block diagram of a system for determining dependencies, in accordance with aspects.

FIG. 1b is a block diagram of a system for transforming determined benchmark dependencies into a directed graph, in accordance with aspects.

FIG. 1c is a block diagram of a system for generating a direct acyclic graph from a directed graph, in accordance with aspects.

FIG. 1d is a block diagram of a system for concurrent recalibration of benchmarks in accordance with aspects.

FIG. 2 is a logical flow for managing benchmark and object dependencies, in accordance with aspects.

FIG. 3 is a block diagram of a computing device for implementing certain aspects of the present disclosure.

FIG. 4 is a block diagram of a flow for ML model training and pattern guessing, in accordance with aspects.

### DETAILED DESCRIPTION

Aspects generally relate to systems and methods for managing benchmark and object dependencies.

Benchmarks provide a point of comparison for a category or class of related things. A benchmark may be thought of as, or may include, a model that provides a value for comparison as output. Performance of a similar or related grouping of things may be compared to the benchmark's output comparison value and be reported as either relatively higher or lower than the comparison value. Organizations use benchmarks values to analyze various business metrics against. For instance, an organization may use benchmarks to gauge performance of business units and set business goals, to gauge business growth, to give insights into or spot trends in business challenges or opportunities, to gauge performance of technological assets using digital benchmarking, etc.

Another illustrative example of benchmarks arises in the financial industry. Financial organizations often use benchmarks generated using a financial security index to gauge performance of a portfolio of assets of a similar class or construction as the index. Exemplary market indices include equity indices, bond indices, real estate indices, commodity indices, etc.

A benchmark model's output will depend on various configurable input components and variables. In the exemplary case of a market index benchmark, the methodology used to create the index will affect the corresponding benchmark's output value. For instance, market indices may include parameters such as market capitalization and/or credit rating to determine which organizations are included in an index. Moreover, configuration variables such as whether prices are averaged or weighted, etc., and what (if any) weighting parameters are used will affect an output value of an associated benchmark model. Additionally, input variable data that may change frequently must be updated before benchmark comparison values are recalculated.

The formulas, variables, and other configuration items that a benchmark model requires are referred to herein as “calibrating objects.” Calibrating objects may be thought of as subcomponents and/or sub-models that a benchmark relies on for calculation of its comparison value. Calibrating objects may focus on generating particular data for a benchmark or may provide a particular formula or mathematical equation for use by a benchmark. Parameters of calibrating objects may be adjusted frequently in view of changes in observed values in order to promote accurate comparison values generated by benchmarks. Exemplary calibrating objects may include one or more of the following: weighting factors or sets of weighting factors, one or more vectors of coefficients, linear curves, a prediction algorithm that may include multiple and sum coefficients, variables based on a training data set, constants, etc.

Because of the component nature of calibrating objects, they may be used in more that one benchmark. For instance, exemplary market indices may include a bond index, an equity index, and a mixed index that includes bonds and equities. A benchmark for a mixed index may have a dependency on a calibrating object that the bond index also has a dependency on. Additionally, the benchmark for the mixed index may have a dependency on a calibrating object that the equity index relies on. Calibrating objects, themselves, may also have dependencies on other calibrating objects.

Market index benchmarks provided by financial institutions offer an illustrative example of the complexities of managing dependencies of benchmarks on various calibrating objects and of calibrating objects on other calibrating objects. For instance, a benchmark may have a dependency on several calibrating objects that weight bonds a certain way, several calibrating objects that produce a weighted average of the stock prices of various public companies, and several calibrating objects that compute a return on various real estate securities. Each of these several calibrating objects may have further dependencies on other calibrating objects or other benchmarks.

In accordance with aspects, calibrating objects may be adjusted from time to time so that a model using the calibrating objects to provide a benchmark output reflects observed values. As noted above, however, the number of objects to benchmarks involved is often not one-to-one. Rather, it may involve many (e.g., hundreds) of benchmark models that depend on even more (e.g., thousands) of calibrating objects. Accordingly, frequent recalibration of models in certain environments may represent an extremely high-dimensional undertaking. Techniques described herein address this complexity by isolating and executing thousands of single-dimensional calibrations in a concurrent fashion (e.g., across many compute resources or in a cloud infrastructure).

In accordance with aspects, dependencies of various benchmarks and their corresponding models on various calibrating objects may be determined as an initial step. A calibrating object may be the primary calibrating object that a benchmark is derived from. That is, a benchmark may have a primary association to a particular calibrating object. Dependencies of the particular calibrating object may then be determined. This step may be carried out most efficiently using a machine learning (ML) engine including ML models trained to recognize dependencies of various calibrating objects. For instance, an organization may train a ML model to recognize a correlation among different asset classes such as an equity class and/or a bond class, such that a benchmark exposed to such assets will be inferred to associate to such correlation by the ML model.

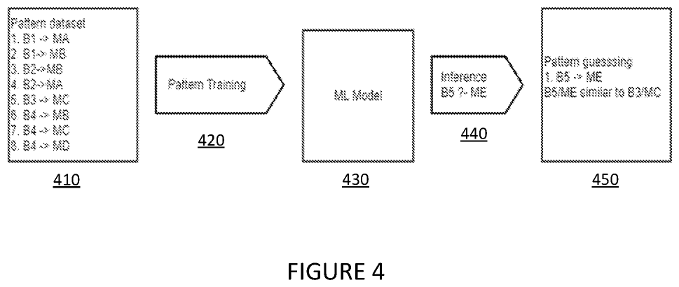

FIG. 4 is a block diagram of a flow for ML model training and pattern guessing, in accordance with aspects. At block 410, a pattern dataset is prepared from historical data. At step 420, pattern training is performed on the ML model 430. At block 440, the trained ML model 430 generates an inference based on the training data set. At block 450, ML model 430 outputs a pattern prediction or “guess,” where benchmark B5 is predicted to have a dependency on calibrating object ME, based on a similar relationship between benchmark B3 and calibrating object MC that was discovered in pattern training step 420.

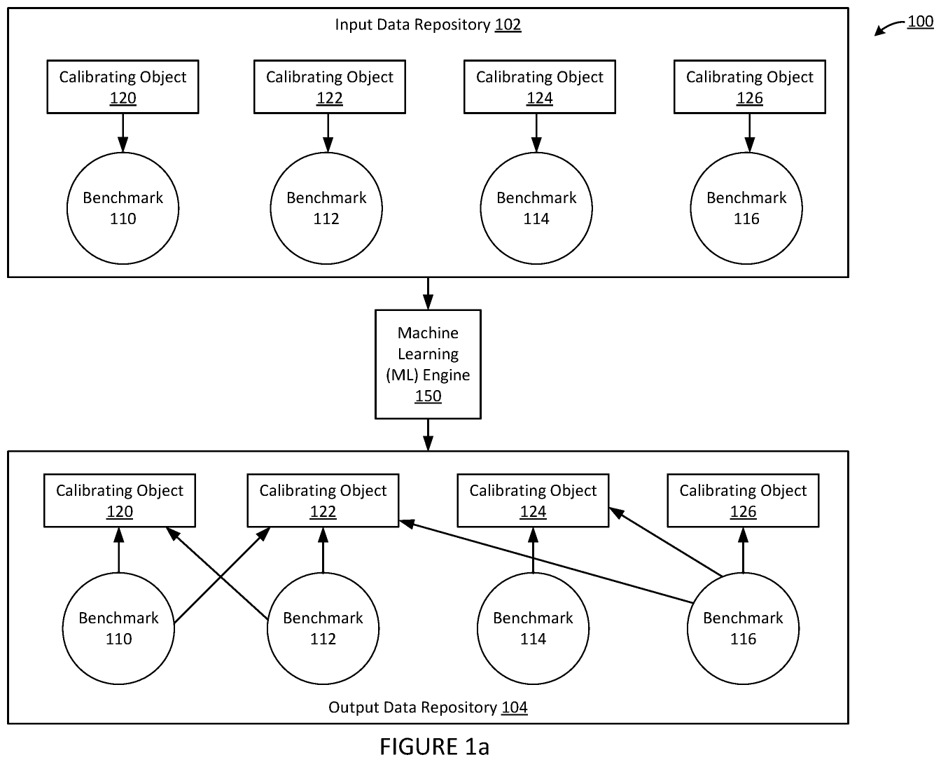

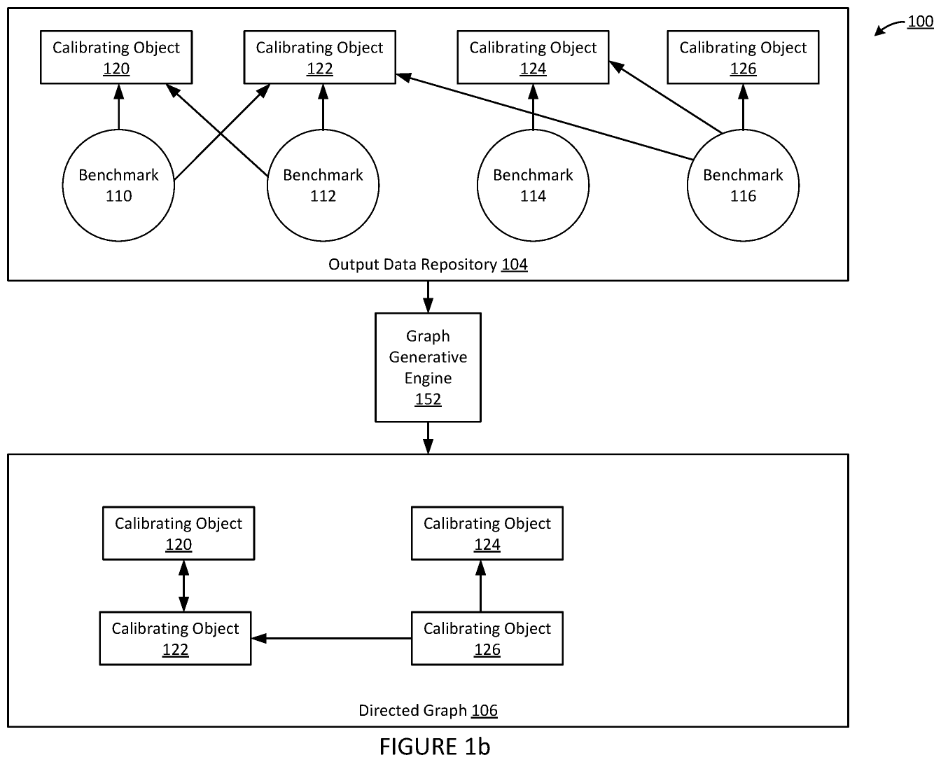

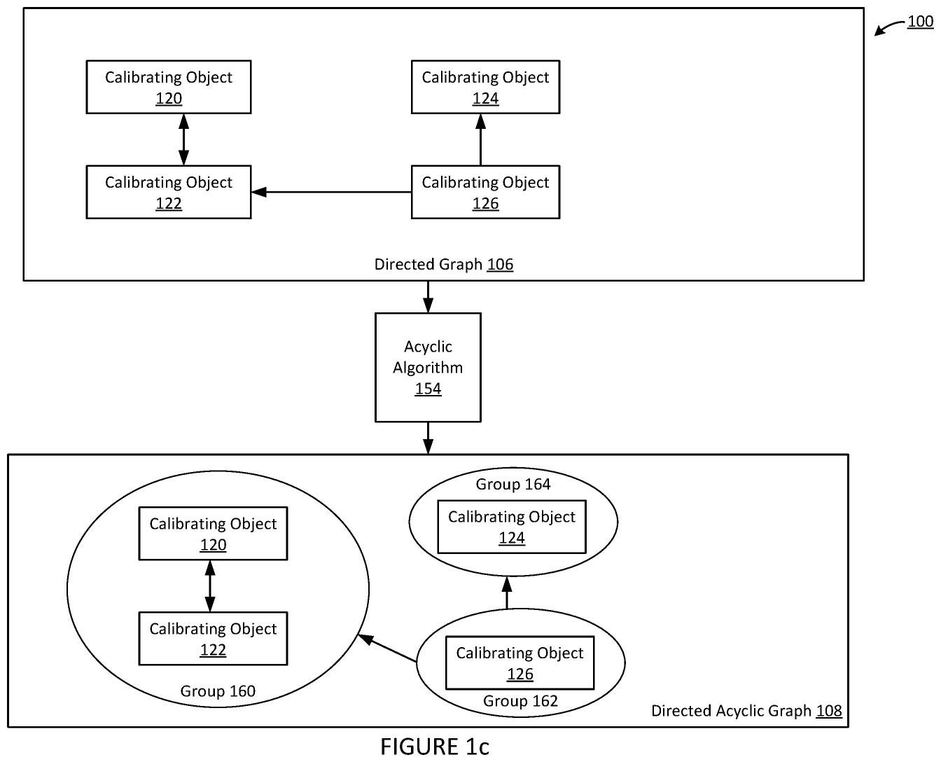

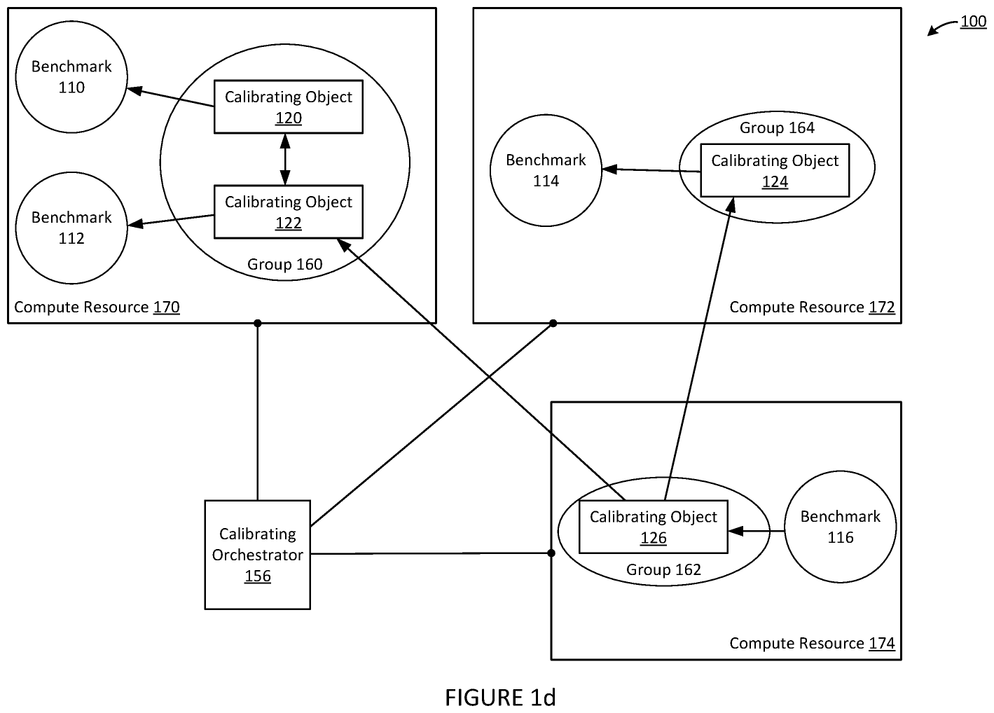

FIG. 1a is a block diagram of a system for determining dependencies, in accordance with aspects. System 100 of FIG. 1a includes benchmark 110, benchmark 112, benchmark 114, and benchmark 116. System 100 further includes calibrating object 120, calibrating object 122, calibrating object 124, and calibrating object 126. Additionally, FIG. 1a includes machine learning (ML) engine 150, input data repository 102, and output data repository 104. While FIG. 1a and the other figures described herein include 4 benchmarks and for calibrating objects, this number of components is meant to be illustrative and exemplary. It is contemplated that, at scale, systems and techniques described herein may house and process large numbers of benchmarks and associated calibrating objects. Indeed, it is anticipated that the techniques described herein may be executed on hundreds of benchmarks and corresponding models and thousands of calibrating objects.

Input data repository 102 and output data repository 104 may each be any suitable storage repository for storing benchmarks and/or calibrating objects. Although depicted as single and separate storage repositories, input data repository 102 and output data repository 104 may each include one or more repositories. For instance, input data repository 102 may include one storage repository for calibrating objects, and one for benchmarks. Likewise, output data repository 104 may include one storage repository for calibrating objects, and one for benchmarks. In some aspects, input data repository 102 and output data repository 104 may be the same datastore. Input data repository 102 and output data repository 104 may be optimized for operative communication with ML engine 150. Exemplary data repositories include relational data bases, NoSQL databases, data lakes, data warehouses, etc. Input data repository 102 and output data repository 104 may include one or more computers configured as data repository servers or engines (e.g., a relational database server, a data warehouse server, etc.).

ML engine 150 may include one or more ML models, each including necessary or desirable model data and prediction algorithms for predicting benchmark dependencies on calibrating objects. ML engine 150 may further include machine learning algorithms for training corresponding models based on historical, synthetic, or other data. ML engine 150 may include one of more computers configured to execute the models.

In accordance with aspects, ML engine 150 may receive benchmark 110, benchmark 112, benchmark 114, and benchmark 116 as input and process the input and provide as output a determination of one or more calibrating objects that the input benchmark depends on. In FIG. 1a, each benchmark is shown having a primary calibrating object associated with it. For instance, benchmark 110 is associated with calibrating object 120, benchmark 112 is associated with calibrating object 122, etc. In some embodiments, primary associates such as these shown in FIG. 1a may be provided. In other aspects, primary associations may be determined by ML engine 150. In some aspects, a calibrating object that is a primary calibrating object for a benchmark may be provided as input to ML engine 150.

In accordance with aspects, output from ML engine 150 may include predictions of calibrating object dependencies for each input benchmark. For instance, referring to FIG. 1a, ML engine 150 has predicted that benchmark 110 depends on calibrating object 120 and calibrating object 122, that benchmark 112 depends on calibrating object 120 and calibrating object 122, that benchmark 114 depends only on calibrating object 124, and that benchmark 116 depends on calibrating object 122, calibrating object 124, and calibrating object 126.

After benchmark dependencies have been identified (e.g., via processing by a ML model), the determined dependencies may be transformed into, and stored as a directed graph. This step may be carried out with a graph generative engine.

FIG. 1b is a block diagram of a system for transforming determined benchmark dependencies into a directed graph, in accordance with aspects. In FIG. 1b, system 100 further includes graph generative engine 152 and directed graph 106. Graph generative engine 152 may include logic and/or generative models for transforming dependencies determined by ML engine 150 into a directed graph. In accordance with aspects, graph generative engine 152 may infer a dependency of a first calibrating object on second calibrating object where the first calibrating object is a primary calibrating object of a benchmark, and that benchmark was determined to have a dependency on the second calibrating object.

Directed graph 106 includes calibrating object 120, calibrating object 122, calibrating object 124, and calibrating object 126 as nodes of directed graph 106. The arrows between calibrating object 120, calibrating object 122, calibrating object 124, and calibrating object 126 represent edges of directed graph 106. The edges indicate either a one-way, or a bidirectional dependency between calibrating objects. For instance, the double arrow between calibrating object 120 and calibrating object 122 in FIG. 1b is an edge that represents a two-way, or bidirectional, dependency (i.e., calibrating object 120 has a dependency on calibrating object 122, and vice versa). As noted above, this is due to benchmark 110 having a primary association with calibrating object 120 and having a dependency on calibrating object 122 while benchmark 112 has a primary association on calibrating object 122 and a dependency on calibrating object 120. Accordingly, graph generative engine 152 is configured to assign a two-way dependency relationship between calibrating object 120 and calibrating object 122 when generating directed graph 106.

Other dependencies shown in directed graph 106 include calibrating object 126 having dependencies on both calibrating object 124 and calibrating object 122. Calibrating object 124 does not have dependencies since benchmark 114 depends only on calibrating object 124.

In accordance with aspects, an acyclic algorithm may take a directed graph representing dependencies among calibrating objects as input, process the directed graph, and output a directed acyclic graph. A directed acyclic graph is a graph with no directed cycles. That is, a directed acyclic graph includes nodes and edges, where the edges are directed from one node to another in such a way that the edge directions never form a closed loop.

An acyclic algorithm may separate a directed graph into a directed acrylic graph whose elements are subgroups of the original directed graph. An acyclic algorithm may partition all nodes into the minimum number of groups that have no interdependencies (i.e., the minimum number of groups with no circular dependencies). That is, after all nodes of the original directed graph are grouped, no group will have an interdependency with any other group because all interdependencies will be self-contained inside of a single group. Put still another way, dependencies between groups will only be one-way dependencies. Accordingly, an acyclic algorithm eliminates any circular dependencies between groups. Generated groups, then, become the nodes of the acyclic graph, with edges representing one-way dependencies.

FIG. 1c is a block diagram of a system for generating a direct acyclic graph from a directed graph, in accordance with aspects. In FIG. 1c, system 100 additionally includes acyclic algorithm 154 and directed acyclic graph 108. Acyclic algorithm 154 includes logic and/or generative models that receive directed graph 106 as input, process directed graph 106, and output directed acyclic graph 108. Directed acyclic graph 108 includes group 160, group 162 and group 164 as nodes. The arrows between the groups of directed acyclic graph 108 represent edges of the graph. Notably, the edges of directed acyclic graph 108 form no closed loops, and any two-way dependencies that existed in directed graph 106 (e.g., as between calibrating object 120 and calibrating object 122) have been encased in a group node (i.e., group 160) in directed acyclic graph 108.

In accordance with aspects, after a directed acyclic graph has been generated as described above, benchmarks and corresponding models may be reassociated with the relevant groups. That is, benchmarks and corresponding models may be reassociated with their primary calibrating object in advance of a recalibration process. Once reassociation has occurred, a calibration orchestrator may assign the determined groups to compute resources that may execute a recalibration process. Recalibration processes may take place currently across various compute resources (e.g., in a distributed cloud environment) for parallel benchmarks and their corresponding models.

For example, calibrating objects encased in groups that have no dependencies, may be assigned to recalibration processes concurrently and before calibrating objects that have dependencies. A calibration orchestrator may assign calibrating objects that have dependencies only after higher-level benchmarks and calibrating objects with no dependencies have been recalibrated. The calibration orchestrator may manage a waterfall output of higher-level recalibration processes such that objects and benchmarks the depend on the higher-level output are not assigned to a compute resource for recalibration until the objects and benchmarks that they depend on have finished, and the output is received and usable by the lower-level benchmarks and calibrating objects. The output may be in the form of a freshly calibrated benchmark or reconfigured calibrating objects.

FIG. 1d is a block diagram of a system for concurrent recalibration of benchmarks in accordance with aspects. In FIG. 1d, system 100 additionally includes calibration orchestrator 156, compute resource 170, compute resource 172, and computer resource 174. In accordance with aspects, benchmarks may be reassociated with their primary calibrating object. In FIG. 1d, benchmark 110 has been reassociated with calibrating object 120, benchmark 112 has been reassociated with calibrating object 122, benchmark 114 has been reassociated with calibrating object 124, and benchmark 116 has been reassociated with calibrating object 126. While this noted reassociated of benchmarks with primary calibrating objects is shown in FIG. 1d, this step may take place in directed acyclic graph 108. That is, benchmarks may be reassociated with their primary calibrating objects as node in directed acyclic graph 108, with appropriate edges representing the (re) association.

Calibration orchestrator 156 may be configured with logic to determine groups of calibrating objects and benchmarks from directed acyclic graph 108 that have no dependencies and assign the calibrating objects in those groups for concurrent processing by various compute resources. Calibrating objects that are determined by calibration orchestrator 156 to have dependencies on other calibrating objects or benchmarks may only be assigned by calibration orchestrator 156 to compute resources for recalibration after the calibrating objects and/or benchmarks that they depend on have finished the recalibration process.

Calibration orchestrator 156 may include logic and hardware for carrying out steps noted herein. Compute resource 170, compute resource 172, and computer resource 174 may include one or more computers, computer processors, memories, and other hardware required to execute a recalibration process. Compute resource 170, compute resource 172, and computer resource 174 may by one or more physical computers or a virtual computing platform that spans one or more physical computers. Compute resource 170, compute resource 172, and computer resource 174 may reside in a public or private cloud and may be provisioned as needed. Compute resource 170, compute resource 172, and computer resource 174 may be capable of parallel or concurrent execution of recalibration processes for various groups of calibrating objects and benchmarks.

In accordance with aspects, calibration orchestrator 156 may determine that group 160 and group 164 are first-level groups, because the calibrating objects herein they have no dependencies outside of their respective groups. Calibrating object 124 has no dependencies at all, and calibrating object 122 and calibrating object 120 only have dependencies on each other (but not outside of group 160). Accordingly, calibration orchestrator 156 may assign group 160 and group 164 to compute resource 170 and compute resource 172 respectively, for concurrent processing. Calibration orchestrator 156, however, may determine that group 162 has a dependency on both calibrating object 122 of group 160 and calibrating object 124 of group 164. Accordingly, calibration orchestrator 156 may identify group 162 as a second level-group and may wait to assign group 162 for processing until one or more first level groups have finished processing.

Calibration orchestrator 156 may wait to assign second-level groups for processing until all first-level groups are finished, or calibration orchestrator 156 may assign second-level groups to compute resources when any first level groups that a second-level group has a dependency on are finished processing. Thus, when group 160 and group 164 have finished their respective recalibration processes, calibration orchestrator 156 assigns group 162 to computer resource 174 for recalibration.

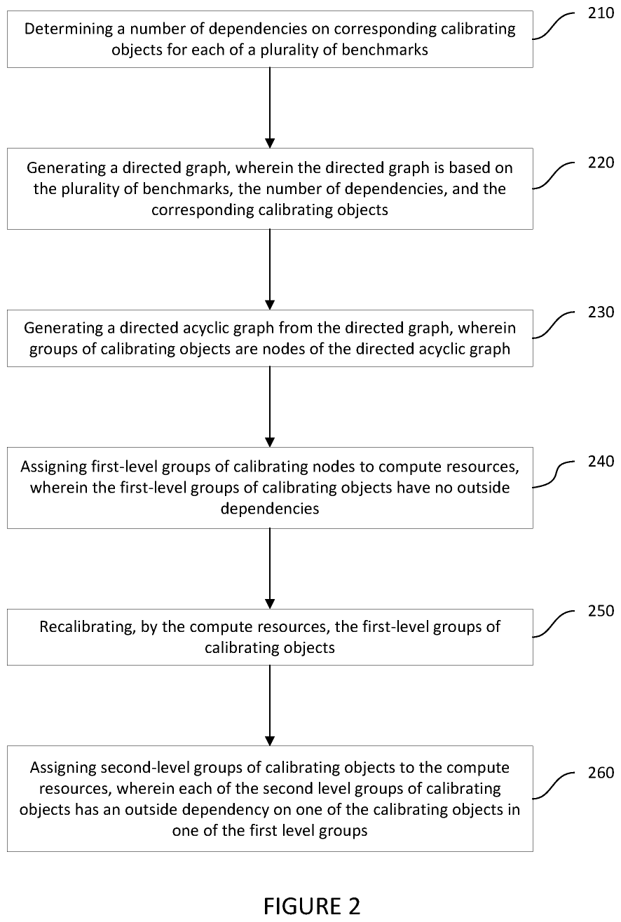

FIG. 2 is a logical flow for managing benchmark and object dependencies, in accordance with aspects.

Step 210 includes determining a number of dependencies on corresponding calibrating objects for each of a plurality of benchmarks.

Step 220 includes generating a directed graph, wherein the directed graph is based on the plurality of benchmarks, the number of dependencies, and the corresponding calibrating objects.

Step 230 includes generating a directed acyclic graph from the directed graph, wherein groups of calibrating objects are nodes of the directed acyclic graph.

Step 240 includes assigning first-level groups of calibrating nodes to compute resources, wherein the first-level groups of calibrating objects have no outside dependencies.

Step 250 includes recalibrating, by the compute resources, the first-level groups of calibrating objects.

Step 260 includes assigning second-level groups of calibrating objects to the compute resources, wherein each of the second level groups of calibrating objects has an outside dependency on one of the calibrating objects in one of the first level groups.

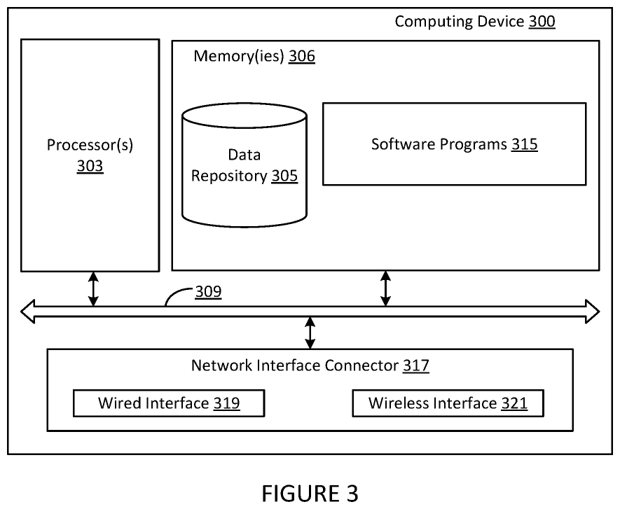

FIG. 3 is a block diagram of a computing device for implementing certain aspects of the present disclosure. FIG. 3 depicts exemplary computing device 300. Computing device 300 may represent hardware that executes the logic that drives the various system components described herein. For example, system components such as a ML engine, a graph generative engine, an acyclic algorithm, a calibrating orchestrator, various database engines and database servers including for storage of data in a graph format, and other computer applications and logic may include, and/or execute on, components and configurations like, or similar to, computing device 300.

Computing device 300 includes a processor 303 coupled to a memory 306. Memory 306 may include volatile memory and/or persistent memory. The processor 303 executes computer-executable program code stored in memory 306, such as software programs 315. Software programs 315 may include one or more of the logical steps disclosed herein as a programmatic instruction, which can be executed by processor 303. Memory 306 may also include data repository 305, which may be nonvolatile memory for data persistence. The processor 303 and the memory 306 may be coupled by a bus 309. In some examples, the bus 309 may also be coupled to one or more network interface connectors 317, such as wired network interface 319, and/or wireless network interface 321. Computing device 300 may also have user interface components, such as a screen for displaying graphical user interfaces and receiving input from the user, a mouse, a keyboard and/or other input/output components (not shown).

The various processing steps, logical steps, and/or data flows depicted in the figures and described in greater detail herein may be accomplished using some or all of the system components also described herein. In some implementations, the described logical steps may be performed in different sequences and various steps may be omitted. Additional steps may be performed along with some, or all of the steps shown in the depicted logical flow diagrams. Some steps may be performed simultaneously. Accordingly, the logical flows illustrated in the figures and described in greater detail herein are meant to be exemplary and, as such, should not be viewed as limiting. These logical flows may be implemented in the form of executable instructions stored on a machine-readable storage medium and executed by a processor and/or in the form of statically or dynamically programmed electronic circuitry.

The system of the invention or portions of the system of the invention may be in the form of a “processing machine” a “computing device,” an “electronic device,” a “mobile device,” etc. These may be a general-purpose computer, a computer server, a host machine, etc. As used herein, the term “processing machine,” “computing device, “electronic device,” or the like is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular step, steps, task, or tasks, such as those steps/tasks described above. Such a set of instructions for performing a particular task may be characterized herein as an application, computer application, program, software program, or simply software. In one aspect, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example. The processing machine used to implement the invention may utilize a suitable operating system, and instructions may come directly or indirectly from the operating system.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further aspect of the invention, be performed by a single component. Further, the processing performed by one distinct component as described above may be performed by two distinct components. In a similar manner, the memory storage performed by two distinct memory portions as described above may, in accordance with a further aspect of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various aspects of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by a processor.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some aspects of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many aspects and adaptations of the present invention other than those herein described, as well as many variations, modifications, and equivalent arrangements, will be apparent from or reasonably suggested by the present invention and foregoing description thereof, without departing from the substance or scope of the invention.

Accordingly, while the present invention has been described here in detail in relation to its exemplary aspects, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such aspects, adaptations, variations, modifications, or equivalent arrangements.

1. A method comprising:
determining a number of dependencies on corresponding calibrating objects for each of a plurality of benchmarks;
generating a directed graph, wherein the directed graph is based on the plurality of benchmarks, the number of dependencies, and the corresponding calibrating objects;
generating a directed acyclic graph from the directed graph, wherein groups of calibrating objects are nodes of the directed acyclic graph;
assigning first-level groups of calibrating objects to compute resources, wherein the first-level groups of calibrating objects have no outside dependencies;
recalibrating, by the compute resources, the first-level groups of calibrating objects; and
assigning second-level groups of calibrating objects to the compute resources, wherein each of the second-level groups of calibrating objects has an outside dependency on a one of the calibrating objects in one of the first-level groups of calibrating objects.

2. The method of claim 1, comprising:
recalibrating, by the compute resources, the second-level groups of calibrating objects.

3. The method of claim 2, wherein recalibrating the second-level groups of calibrating objects uses calibrating objects from the first-level groups of calibrating objects.

4. The method of claim 1, wherein a first group in the first-level groups of calibrating objects is assigned to a first compute resource and a second group in the first-level groups of calibrating objects is assigned to a second compute resource.

5. The method of claim 4, wherein the first compute resource and the second compute resource recalibrate the first group and the second group concurrently.

6. The method of claim 1, wherein a benchmark is re-associated with a corresponding calibrating object in one of the first-level groups of calibrating objects.

7. The method of claim 6, wherein the benchmark is recalibrated.

8. A system comprising at least one computer including a processor, wherein the at least one computer is configured to:
determine a number of dependencies on corresponding calibrating objects for each of a plurality of benchmarks;
generate a directed graph, wherein the directed graph is based on the plurality of benchmarks, the number of dependencies, and the corresponding calibrating objects;
generate a directed acyclic graph from the directed graph, wherein groups of calibrating objects are nodes of the directed acyclic graph;
assign first-level groups of calibrating objects to compute resources, wherein the first-level groups of calibrating objects have no outside dependencies;
recalibrate, by the compute resources, the first-level groups of calibrating objects; and
assign second-level groups of calibrating objects to the compute resources, wherein each of the second-level groups of calibrating objects has an outside dependency on a one of the calibrating objects in one of the first-level groups of calibrating objects.

9. The system of claim 8, wherein the at least one computer is configured to:
recalibrating, by the compute resources, the second-level groups of calibrating objects.

10. The system of claim 9, wherein recalibrating the second-level groups of calibrating objects uses calibrating objects from the first-level groups of calibrating objects.

11. The system of claim 8, wherein a first group in the first-level groups of calibrating objects is assigned to a first compute resource and a second group in the first-level groups of calibrating objects is assigned to a second compute resource.

12. The system of claim 11, wherein the first compute resource and the second compute resource recalibrate the first group and the second group concurrently.

13. The system of claim 8, wherein a benchmark is re-associated with a corresponding calibrating object in one of the first-level groups of calibrating objects.

14. The system of claim 13, wherein the benchmark is recalibrated.

15. A non-transitory computer readable storage medium, including instructions stored thereon, which instructions, when read and executed by one or more computer processors, cause the one or more computer processors to perform steps comprising:
determining a number of dependencies on corresponding calibrating objects for each of a plurality of benchmarks;
generating a directed graph, wherein the directed graph is based on the plurality of benchmarks, the number of dependencies, and the corresponding calibrating objects;
generating a directed acyclic graph from the directed graph, wherein groups of calibrating objects are nodes of the directed acyclic graph;
assigning first-level groups of calibrating objects to compute resources, wherein the first-level groups of calibrating objects have no outside dependencies;
recalibrating, by the compute resources, the first-level groups of calibrating objects; and
assigning second-level groups of calibrating objects to the compute resources, wherein each of the second-level groups of calibrating objects has an outside dependency on a one of the calibrating objects in one of the first-level groups of calibrating objects.

16. The non-transitory computer readable storage medium of claim 15, comprising:
recalibrating, by the compute resources, the second-level groups of calibrating objects.

17. The non-transitory computer readable storage medium of claim 16, wherein recalibrating the second-level groups of calibrating objects uses calibrating objects from the first-level groups of calibrating objects.

18. The non-transitory computer readable storage medium of claim 15, wherein a first group in the first-level groups of calibrating objects is assigned to a first compute resource and a second group in the first-level groups of calibrating objects is assigned to a second compute resource.

19. The non-transitory computer readable storage medium of claim 18, wherein the first compute resource and the second compute resource recalibrate the first group and the second group concurrently.

20. The non-transitory computer readable storage medium of claim 15, wherein a benchmark is re-associated with a corresponding calibrating object in one of the first-level groups of calibrating objects.
